(19) United States
(12) Patent Application Publication
(10) Pub. No.: US 2010/0238123 A1
(43) Pub. Date: Sep. 23, 2010

(54) Input Device Gesture To Generate Full Screen Change

(76) Inventors: Orin M. Ozias, Austin, TX (US); Hans Eilers, Cedar Park, TX (US); Erin K. Walline, Pflugerville, TX (US)

Correspondence Address: HAMILTON & TERRILE, LLP, P.O. BOX 203518, AUSTIN, TX, 78720, US

(21) Appl. No.: 12/405,700

(22) Filed: Mar. 17, 2009

(51) Int. Cl. G06F 3/041; G06F 3/033

(52) U.S. Cl. 345/173; 715/863

(57) ABSTRACT

A gesture based method for generating a screen presentation content change. The gesture based method for generating a screen presentation content change used a gesture (such as e.g., a full palm or multi-finger gesture) on a touchpad or a touch sensitive display screen that generates a screen presentation content change.

### BACKGROUND OF THE INVENTION

1. Field of the Invention

The present invention relates to the field of information handling systems and more particularly to input gestures used with information handling systems.

2. Description of Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to present information on a display device of the information handling system. It is also known to generate a relatively immediate screen presentation content change such as a full screen change. Often this type of screen presentation content change is referred to as a privacy mode (also sometimes referred to as boss mode). In known systems, the screen presentation content change is generated via a specific keystroke combination (e.g., in certain systems, providing a keystroke combination of the Windows function key and either the M key or the D key causes the operating system to minimize open windows to the desktop). The specific keystroke combination may or may not consistently function in all applications executing on the information handling system.

Accordingly, it is desirable to provide a method of generating a screen presentation content change that is consistent across all applications executing on an information handling system. It is also desirable to provide a method of generating a screen presentation content change that is easier and more intuitive to activate.

### SUMMARY OF THE INVENTION

In accordance with the present invention, a gesture based method for generating a screen presentation content change is disclosed. More specifically, the gesture based method for generating a screen presentation content change used a gesture (such as e.g., a full palm or multi-finger gesture) on a touchpad or a touch sensitive display screen that generates a screen presentation content change. In certain embodiments, if the gesture is repeated within a certain amount of time then the screen presentation content change is reversed. Also, in certain embodiments, the reversal of the screen presentation content change may or may not be set as a default.

Such a method is consistent across all applications executing on an information handling system. Additionally, such a method generates a screen presentation content change that is easier and more intuitive to activate.

More specifically, in one embodiment, the invention relates to a method for generating a screen presentation content change on an information handling system. The method includes generating a screen presentation; monitoring for a predefined input gesture; and generating a screen presentation content change in response to detection of the predefined input gesture.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows block diagram of an information handling system having a system for generating a screen presentation content change.

FIG. 2 shows a flow chart of the operation of the system for generating a screen presentation content change.

FIG. 3 shows a diagrammatic representation of a touchpad in combination with an example screen presentation.

FIG. 4 shows a diagrammatic representation of a touchpad in combination with an example screen presentation with an example input gesture.

FIG. 5 shows a diagrammatic representation of a touchpad in combination with an example screen presentation content change in response to the example input gesture.

FIG. 6 shows a diagrammatic representation of a touchpad in combination with an example resulting screen presentation content change in response to the example input gesture.

FIG. 7 shows a diagrammatic representation of a control menu for the system for generating a screen presentation content change.

### DETAILED DESCRIPTION

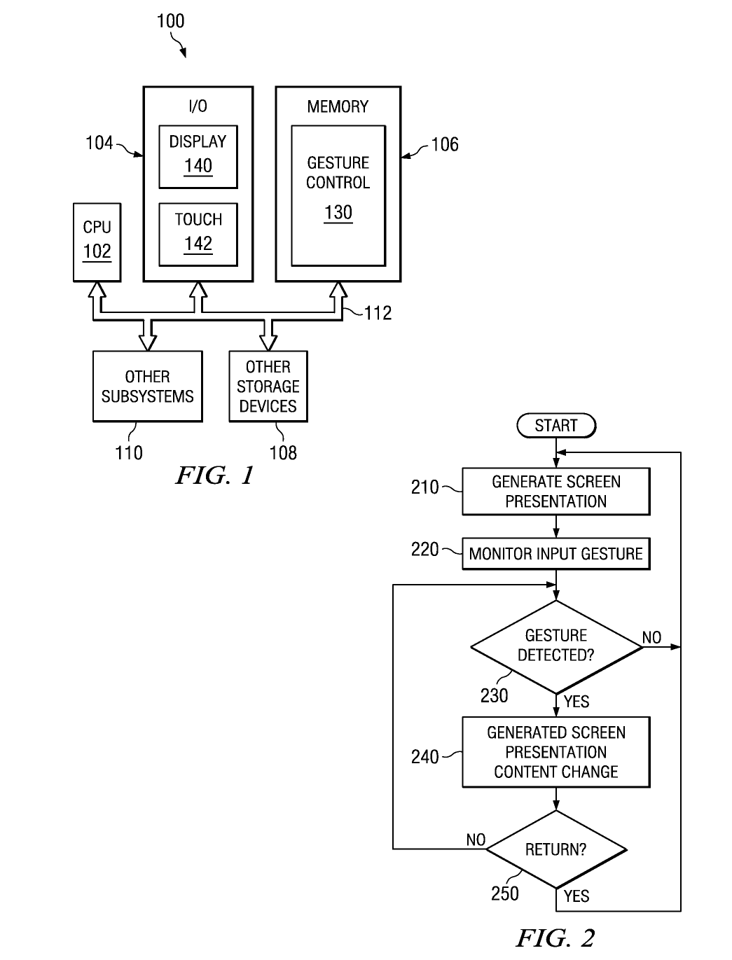

Referring to FIG. 1, a system block diagram of an information handling system 100 such as target information handling system 120 is shown. The information handling system 100 includes a processor 102, input/output (I/O) devices 104, such as a display, a keyboard, a mouse, and associated controllers, memory 206 including non-volatile memory such as a hard disk drive and volatile memory such as random access memory, and other storage devices 108, such as a floppy disk and drive and other memory devices, and various other subsystems 110, all interconnected via one or more buses, shown collectively as bus 112.

The memory stores a gesture control system 130 which includes instructions which are executed by the processor 102 to cause the information handling system to function in a prescribed manner. The I/O devices further include a display device 140 as well as a touch sensitive input device 142. The touch sensitive input device 142 may be a touch pad or may be a touch sensitive type display device.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

FIG. 2 shows a flow chart of the operation 200 of the system for generating a screen presentation content change (e.g., the gesture control system 130). More specifically, operation of the system for generating a screen presentation content change starts operation by generating a screen presentation at step 210. The screen presentation is presented on the display device 140 and can include a desktop as well as one or more icons presented on the desktop as well as one or more applications on the desktop. Next, the system monitors for a predefined input gesture at step 220. The input gesture is a full palm or multi-finger gesture that entered via the touch sensitive input device 142. If no predefined input gesture is detected at step 230, then the system continues to generate the screen presentation at step 210.

If the predefined input gesture is detected at step 230, then the system for generating a screen presentation content change generates a screen presentation content change at step 240. The screen presentation content change may be causing the display to present only the desktop screen presentation or some other innocuous screen presentation. After the innocuous screen presentation is generated, then the system determines whether there is an indication to return to the previous screen presentation at step 250. This determination may be in the form of monitoring for another input gesture or a repeat of the previous input gesture.

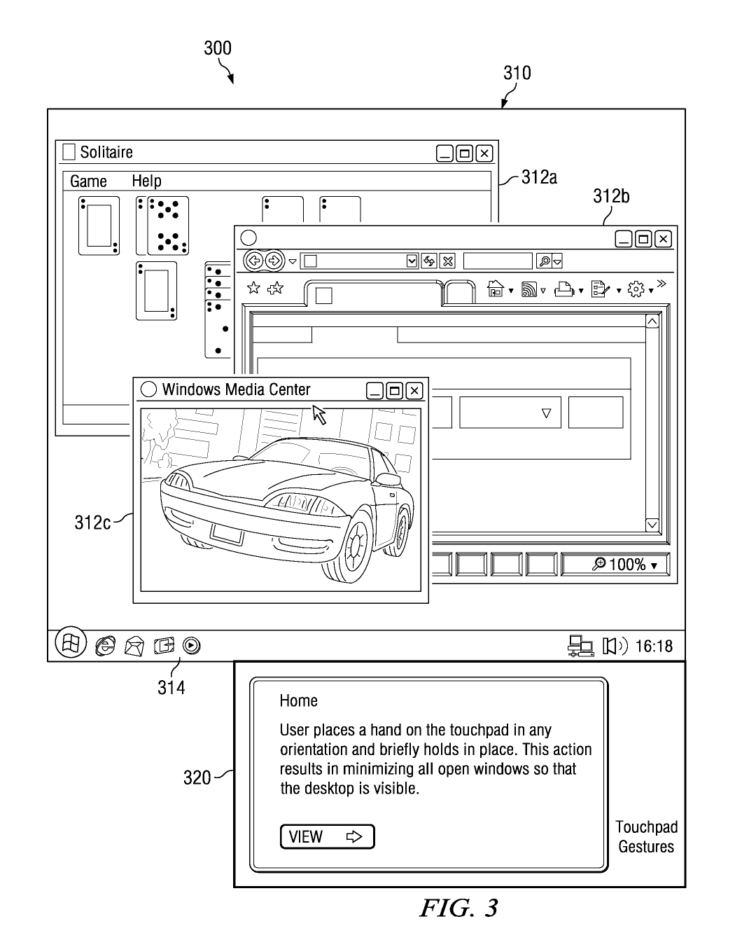

FIG. 3 shows a diagrammatic representation 300 of a touchpad in combination with an example screen presentation. More specifically, the diagrammatic representation 300 includes a screen presentation portion 310. The screen presentation includes a plurality of application presentations 312a, 312b, 312c as well as a task bar presentation 314. As is known in the art, the task bar presentation 314 can include a plurality of elements such as a start icon. The diagrammatic representation 300 further includes a touchpad portion 320. The touchpad portion 320 may correspond to a touch pad input device 142.

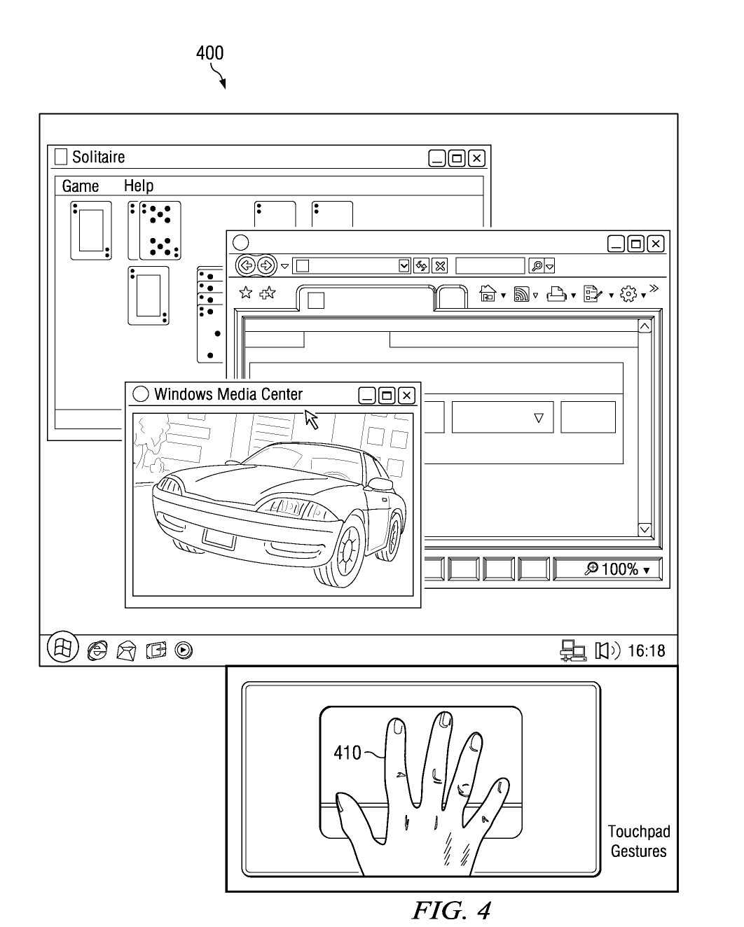

FIG. 4 shows a diagrammatic representation 400 of a touchpad in combination with an example screen presentation with an example input gesture. More specifically, the gesture control system 130 can detect a predefined input gesture such as a full palm or multi-finger input gesture 410.

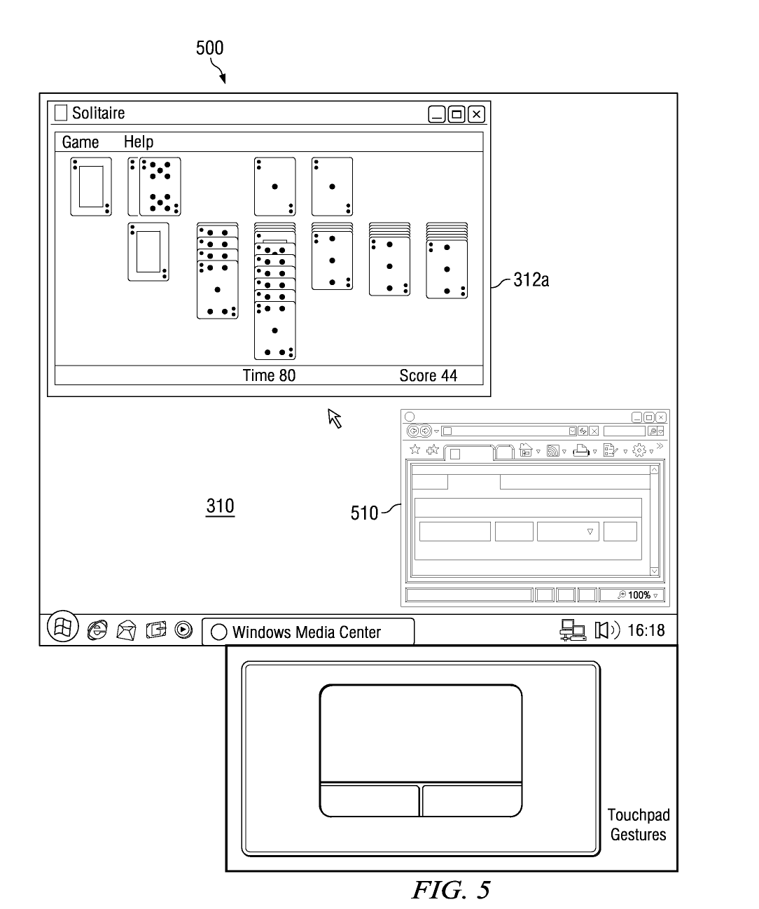

FIG. 5 shows a diagrammatic representation 500 of a touchpad in combination with an example screen presentation content change in response to the example input gesture. More specifically, upon detection of a predefined input gesture, the screen presentation begins to change its appearance to an innocuous screen presentation. This change in appearance can be indicated by a ghosting 510 of each of the application presentations 312 as each application presentation is minimized.

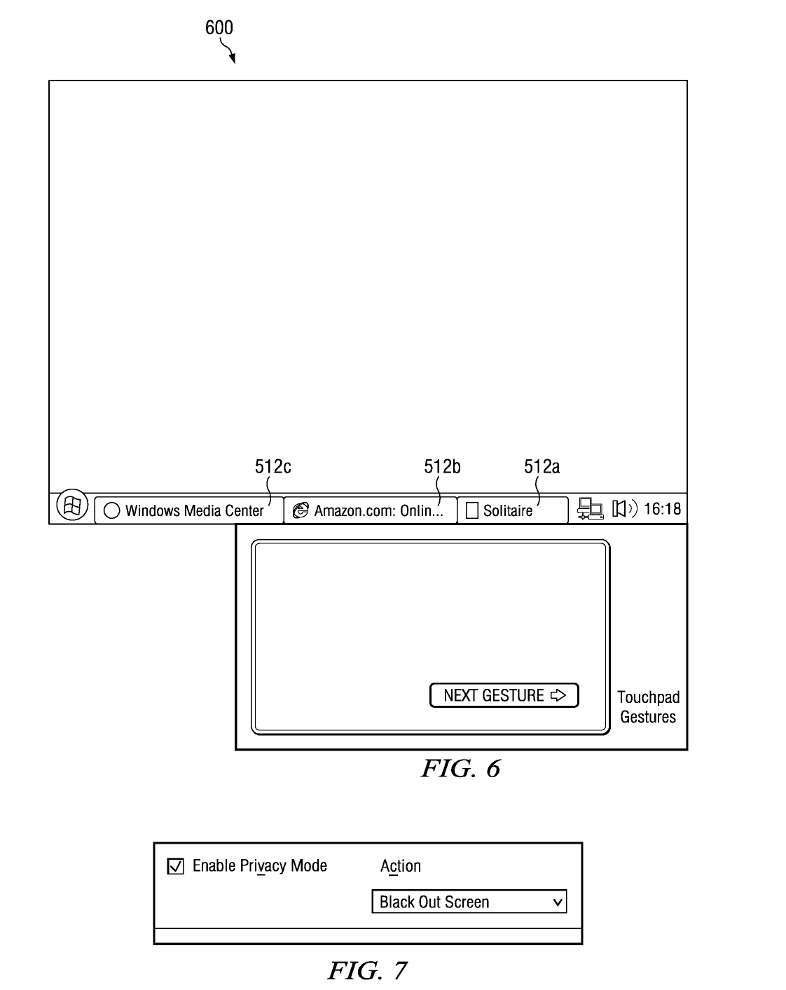

FIG. 6 shows a diagrammatic representation 600 of a touchpad in combination with an example resulting screen presentation content change in response to the example input gesture. More specifically, after each of the application presentations 312 are minimized, an icon 612a, 612b, 612c corresponding to a respective screen presentation is included within the task bar presentation 314.

Referring to FIG. 7, a diagrammatic representation of a control menu for the system for generating a screen presentation content change is shown. More specifically, using the control menu, a user can enable or disable privacy mode and can also select a type of action to be performed upon detection of the input gesture. For example, the type of action can include a blank screen content change operation, a minimize all windows operation and a lock desktop operation.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for generating a screen presentation content change on an information handling system comprising:
generating a screen presentation;
monitoring for a predefined input gesture;
generating a screen presentation content change in response to detection of the predefined input gesture.

2. The method of claim 1 wherein:
the monitoring monitors a touch sensitive input device.

3. The method of claim 2 wherein:
the touch sensitive input device comprises at least one of a touch pad and a touch sensitive display device.

4. The method of claim 1 wherein:
the defined input gesture comprises at least one of a full palm input gesture and a multifinger gesture.

5. The method of claim 1 wherein:
if the predefined input gesture is repeated within a certain amount of time then the screen presentation content change is reversed.

6. The method of claim 5 wherein:
reversal of the screen presentation content change is set as a default operation.

7. An apparatus for generating a screen presentation content change on an information handling system comprising:
means for generating a screen presentation;
means for monitoring for a predefined input gesture;
means for generating a screen presentation content change in response to detection of the predefined input gesture.

8. The apparatus of claim 7 wherein:
the monitoring monitors a touch sensitive input device.

9. The apparatus of claim 8 wherein:
the touch sensitive input device comprises at least one of a touch pad and a touch sensitive display device.

10. The apparatus of claim 7 wherein:
the defined input gesture comprises at least one of a full palm input gesture and a multifinger gesture.

11. The apparatus of claim 7 wherein:
if the predefined input gesture is repeated within a certain amount of time then the screen presentation content change is reversed.

12. The apparatus of claim 11 wherein:
reversal of the screen presentation content change is set as a default operation.

13. An information handling system comprising:
a processor;
memory coupled to the processor, the memory storing a gesture control system, the gesture control system comprising program code executable on the processor for generating a screen presentation content change, the program code
generating a screen presentation;
monitoring for a predefined input gesture;
generating a screen presentation content change in response to detection of the predefined input gesture.

14. The information handling system of claim 13 further comprising:
a touch sensitive input device coupled to the processor and wherein the monitoring monitors a touch sensitive input device.

15. The information handling system of claim 14 wherein:
the touch sensitive input device comprises at least one of a touch pad and a touch sensitive display device.

16. The information handling system of claim 13 wherein:
the defined input gesture comprises at least one of a full palm input gesture and a multifinger gesture.

17. The information handling system of claim 13 wherein:
if the predefined input gesture is repeated within a certain amount of time then the screen presentation content change is reversed.

18. The information handling system of claim 17 wherein:
reversal of the screen presentation content change is set as a default operation.
